(19) United States
(12) Patent Application Publication
(10) Pub. No.: US 2026/0308016 A1
(43) Pub. Date: Oct. 8, 2026

(54) SELF-MANAGED WATER PURIFIER

(71) Applicant: COWAY CO., LTD., Gongju-si (KR)

(72) Inventors: Sung Jae LEE, Gongju-si (KR); Hyun Goo KIM, Gongju-si (KR); Bong Suk KIM, Gongju-si (KR); Da Woon JUNG, Gongju-si (KR); Yoo Won OH, Gongju-si (KR); Hee Do JUNG, Gongju-si (KR); Sang Woo BANG, Gongju-si (KR); Dong Min OH, Gongju-si (KR); Seung Won LEE, Gongju-si (KR)

(73) Assignee: COWAY CO., LTD., Gongju-si (KR)

(21) Appl. No.: 19/481,720

(22) PCT Filed: Mar. 5, 2024
(86) PCT No.: PCT/KR2024/002820

§ 371 Date: Nov. 5, 2025

(30) Foreign Application Priority Data
Jun. 14, 2023 (KR) 10-2023-0076127

(51) Int. Cl. C02F 1/00

(52) U.S. Cl. CPC C02F 1/001; C02F 1/008; C02F 2201/005; C02F 2209/02; C02F 2209/42; C02F 2307/10

(57) ABSTRACT

Disclosed in the present invention is a self-managed water purifier with improved user convenience. The self-managed water purifier according to an aspect of the present invention may comprise; a housing: a tank; a tank coupling module unity a valve unit; a frame unit; and a front cover unit.

### TECHNICAL FIELD

The present invention relates to a water purifier, and more particularly, to a self-managed water purifier with enhanced user convenience.

### BACKGROUND

In general, a water purifier is an apparatus for purifying raw water supplied from a raw water supply source such as a tap water or bottled water, and is an apparatus that supplies purified water to users by removing impurities such as heavy metals and other harmful substances contained in raw water through physical or chemical methods such as precipitation, filtration, sterilization, and the like.

Such a water purifier has a structure in which the supplied raw water flows sequentially through different filtration members provided inside a filter, thereby supplying purified water, which is the final result of filtration, to the user.

Meanwhile, after a certain period of use, such a water purifier requires regular cleaning or replacement of the filter, piping, or faucet to prevent bacteria or microorganisms from inhabiting the interior thereof.

However, conventional water purifiers have the disadvantage that professional technicians in the water purifier field (commonly referred to as water purifier coordinators) must visit in person to clean or replace the filter, piping, or faucet, and that the cleaning must be performed using disinfectants such as chlorine or steam, or by replacing the filter or piping.

Meanwhile, for a professional technician from a water purifier company to inspect components such as the filter, piping, and faucet, it is necessary to enter the location where the water purifier is installed, which is inconvenient and may raise concerns about privacy infringement and potential security issues.

To address these problems, a water purifier structure has been proposed in which the components of the water purifier are modularized to facilitate replacement and allow users to manage them directly.

For example, Korean Laid-Open Patent Publication No. 10-2003-0078433 entitled “Storage tank of a water purifier,” Korean Registered Patent Publication No. 10-1987942 entitled “One-touch flow path pipe replacement modular water purifier,” and Korean Laid-Open Patent Publication No. 10-2019-0024760 entitled “A water purifier of self management type” have been disclosed.

However, Korean Laid-Open Patent Publication No. 10-2003-0078433 relates only to a structure in which the user can separate and clean the Storage tank of the water purifier, and Korean Registered Patent Publication No. 10-1987942 discloses only the replacement of a water discharge flow path (purified water flow path), without disclosing the structure or arrangement of modules for improving user convenience in self-managing the overall purification system.

Meanwhile, Korean Laid-Open Patent Publication No. 10-2019-0024760 considers only the replacement of the filter and does not address management of the flow paths through which raw water and purified water flow. Therefore, it still involves the issue of requiring professional technicians from the water purifier company to manage the internal flow paths of the water purifier.

Meanwhile, in a modular water purifier structure, functional components mounted on the flow paths, such as sensor modules or discharge (faucet) modules, must be replaced or removed in the event of aging or malfunction. In such cases, it is necessary to shut off the raw water supplied to the water purifier or drain all the water stored in the tank in order to prevent the raw or purified water from being discharged under water pressure.

However, it is often difficult for users to carry out such preparatory actions for replacing components, and there are frequent cases in which users attempt to perform replacements without shutting off the raw water supply or draining the water stored in the tank.

In other words, in conventional water purifiers, when a sensor coupled to the tank or a discharge valve (solenoid valve) fluidly connected to the tank is replaced, the water stored in the tank is inevitably discharged through the hole from which the sensor or discharge valve has been removed, as if pouring out.

To prevent the discharge of water from the tank through the hole during such component replacement, the water in the tank must be completely drained before replacing the component.

However, draining the water from the tank takes a considerable amount of time, and in the case where the user directly manages the water purifier, there is a high likelihood that the user may overlook or be unaware of the need to drain the tank before replacing the component.

### DISCLOSURE

### Technical Problem

The present invention is to solve the above problems, and the present invention is directed to providing a self-managed water purifier configured to allow easy replacement of a tank coupling module unit connected through a tank discharge port in a water storage-type water purifier including a tank, and to enable the tank coupling module unit to be simply and easily replaced without a preceding action for preventing leakage of raw water.

The present invention is also directed to providing a self-managed water purifier configured to allow simple and easy replacement of a discharge module or the like having a coupling portion with a purified water discharge port, even in a direct water purifier including the purified water discharge port for discharging filtered purified water, without a preceding action for preventing leakage of raw water.

The present invention is also directed to providing a self-managed water purifier configured to facilitate replacement of a tank coupling module unit by automatically shutting off leakage of purified water through a valve unit, even when a user (consumer) directly manages the water purifier and neglects to empty the water in the tank before replacing the part.

The problems of the present invention are not limited to those mentioned above, and other problems not mentioned will be clearly understood by those of ordinary skill in the art from the following description.

### Technical Solution

According to an aspect of the present invention, a self-managed water purifier is provided.

The self-managed water purifier includes a housing; a tank accommodated in an inner space of the housing, configured to store purified water, and including a tank discharge port; a tank coupling module unit detachably coupled to an outer side of the tank and in fluid communication with the tank through the tank discharge port; a valve unit coupled to the tank discharge port while connecting the tank coupling module unit and the tank, the valve unit being configured to open the tank discharge port when the tank coupling module unit is coupled to the tank and to close the tank discharge port when the tank coupling module unit is separated from the tank; a frame unit accommodated in the inner space of the housing and configured to support the tank coupling module unit; and a front cover unit detachably coupled to a front panel forming a front portion of the housing in a size and shape sufficient to cover the tank coupling module unit, and configured to selectively expose the tank coupling module unit to the outside.

As an example, the tank coupling module unit includes a main body having an internal accommodating space; and a flow path pipe configured to fluidly communicate with the internal accommodating space and extend rearward from the main body.

As an example, the valve unit includes a body having a first flow path hole formed therethrough into which the flow path pipe is inserted; an elastic spring accommodated in a rear region of the body; a flow path coupling member having one side configured to support a rear side of the elastic spring and coupled to the body, and the other side configured to be inserted into and coupled to the tank discharge port, the flow path coupling member having a second flow path hole formed therein to be in fluid communication with the first flow path hole; and an opening/closing member provided at a front end of the elastic spring, and a flow of purified water is opened or closed by compression or release of the opening/closing member.

In this case, the body of the valve unit may have a structure that is formed with a coupling protrusion protruding laterally from an outer circumferential surface, and in which the coupling protrusion is fitted into and supported by a mounting hole formed in the frame unit.

Meanwhile, the body of the valve unit may be divided into a first pipe extending forward from the coupling protrusion and toward the tank coupling module unit, and a second pipe extending rearward from the coupling protrusion and toward the tank.

Meanwhile, as an example, the front panel has an opening hole formed therein in a size allowing the tank coupling module unit to be exposed to the outside. In addition, the front cover unit has an enclosure shape with an open rear and is coupled to a front side of the front panel while covering the opening hole.

Meanwhile, a lower end of the front cover unit in contact with the front panel may be pivotably coupled to the front panel via a rotation member, and the front cover unit may expose the tank coupling module unit to the outside by tilting an upper portion forward about the lower end as an axis.

In an embodiment, the tank coupling module unit includes a sensor module that is supported by the frame unit and detachably coupled to a front side of the tank, and that detects a temperature or a water level of purified water in the tank by coming into contact with the purified water introduced through the valve unit; and a discharge module that is supported by the frame unit and detachably coupled to the front side of the tank, and that discharges the purified water introduced through the valve unit to the outside.

Meanwhile, the frame unit includes a sensor module seating groove in which the sensor module is accommodated while being seated from front to rear and which is provided with a terminal portion electrically connected to the sensor module through terminal contact; and a discharge module seating groove in which the discharge module is accommodated while being seated from front to rear and which is provided with a terminal portion electrically connected to the discharge module through terminal contact.

As an example, the sensor module includes a sensor module main body having an internal accommodating space; a sensor module flow path pipe that is in fluid communication with the internal accommodating space, extends rearward from the sensor module main body, and is connected to the valve unit; a sensing tube having one side supported in the internal accommodating space and the other side arranged to penetrate the sensor module flow path pipe while sealing the sensor module flow path pipe, the sensing tube being provided with a sensor therein; and a circuit board electrically connected to the sensor and disposed in the internal accommodating space such that a contact terminal protrudes outward from the sensor module main body.

In this case, the sensor module flow path pipe and the sensing tube are each formed in a number of at least one.

Meanwhile, the sensor module main body is formed with mounting members protruding laterally on both sides, and the mounting members are detachably coupled to locking members rotatably disposed on the frame unit.

As an example, the discharge module includes a discharge module main body having an internal accommodating space; a discharge module flow path pipe that is in fluid communication with the internal accommodating space, extends rearward from the discharge module main body, and is connected to the valve unit; a faucet connected to the discharge module flow path pipe within the internal accommodating space and extending outward from the discharge module main body; a solenoid valve disposed in the internal accommodating space and connecting the discharge module flow path pipe to the faucet; and a circuit board electrically connected to the solenoid valve and disposed in the internal accommodating space such that a contact terminal protrudes outward from the discharge module main body.

In this case, the discharge module flow path pipe and the faucet are each formed in a number of at least one.

Meanwhile, the discharge module main body is formed with mounting members protruding laterally on both sides, and the mounting members arc detachably coupled to locking members rotatably disposed on the frame unit.

Meanwhile, in the self-managed water purifier, the tank includes at least two of a purified water tank, a cold water tank, and a hot water tank. In this case, the tank coupling module unit is detachably coupled to at least two of the purified water tank, the cold water tank, and the hot water tank.

Meanwhile, according to another aspect of the present invention, another embodiment of the self-managed water purifier is disclosed.

The self-managed water purifier includes a housing; a purified water discharge port accommodated in an internal space of the housing and configured to discharge purified water filtered through a filter unit; a frame unit accommodated in the internal space of the housing; a discharge module unit detachably coupled to the frame unit, fluidly communicating with the purified water discharge port, and configured to discharge the purified water from the purified water discharge port to the outside; a valve unit coupled to the purified water discharge port, the valve unit opening the purified water discharge port when the discharge module unit is coupled to the purified water discharge port, and closing the purified water discharge port when the discharge module unit is separated from the purified water discharge port; and a front cover unit detachably coupled to a front panel forming a front portion of the housing in a size and shape sufficient to cover the discharge module unit, and configured to selectively expose the discharge module unit to the outside.

In this case, as an example, the discharge module unit includes a discharge module unit main body having an internal accommodating space; a discharge module unit flow path pipe that is in fluid communication with the internal accommodating space, extends rearward from the discharge module unit main body, and is connected to the valve unit; a faucet connected to the discharge module unit flow path pipe within the internal accommodating space and extending outward from the discharge module unit main body; a solenoid valve disposed in the internal accommodating space and connecting the discharge module unit flow path pipe to the faucet: and a circuit board electrically connected to the solenoid valve and disposed in the internal accommodating space such that a contact terminal protrudes outward from the discharge module unit main body.

Meanwhile, as an example, the valve unit includes a body having a first flow path hole formed therethrough into which the discharge module unit flow path pipe is inserted; an elastic spring accommodated in a rear region of the body; a flow path coupling member having one side configured to support a rear side of the elastic spring and coupled to the body, and the other side configured to be inserted into and coupled to the purified water discharge port, the flow path coupling member having a second flow path hole formed therein to be in fluid communication with the first flow path hole; and
an opening/closing member provided at a front end of the elastic spring, and a flow of purified water is opened or closed by compression or release of the opening/closing member.

Meanwhile, a lower end of the front cover unit in contact with the front panel is pivotably coupled to the front panel via a rotation member, and the front cover unit exposes the discharge module unit to the outside by tilting an upper portion forward about the lower end as an axis.

In addition, the purified water discharge port includes at least two of a purified water discharge port for discharging purified water at room temperature, a purified water discharge port for discharging purified water at a high temperature, and a purified water discharge port for discharging purified water at a low temperature.

In this case, the discharge module unit is detachably coupled to at least two of the purified water discharge port for discharging purified water at room temperature, the purified water discharge port for discharging purified water at a high temperature, and the purified water discharge port for discharging purified water at a low temperature.

### Advantageous Effect

According to the above configuration, the self-managed water purifier according to the present invention allows a tank coupling module unit, which is connected through a tank discharge port in a water storage-type water purifier including a tank, to be easily replaced, and enables such replacement to be performed simply and conveniently without any preceding action for preventing raw water leakage.

In addition, when a user (consumer) directly self-manages the water purifier, even if the user overlooks the need to empty the purified water in the tank before replacing a component, the valve unit automatically blocks leakage of the purified water, thereby enabling the tank coupling module unit to be replaced more easily.

In addition, the tank coupling module unit is in fluid communication with the tank through the valve unit, and the closure of the tank discharge port can be performed upon detachment of the tank coupling module unit without any separate action.

In addition, the front cover unit is hinge-rotated while tilting, simultaneously opening the opening hole of the front panel to allow the tank coupling module unit to be easily detached and replaced toward the front of the water purifier.

In addition, since the front cover unit is hinge-rotated forward while tilting downward, there is no obstruction when detaching the tank coupling module unit toward the front, enabling easy replacement.

In addition, even in a direct water purifier including a purified water discharge port for discharging filtered purified water, the discharge module or the like having a coupling portion with the purified water discharge port can be replaced simply and easily without any prior action to prevent leakage of raw water.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view illustrating a self-managed water purifier according to an exemplary embodiment of the present invention.

FIG. 2 is a schematic exploded perspective view illustrating a self-managed water purifier according to an exemplary embodiment of the present invention.

FIG. 3 is an overall cross-sectional view illustrating a self-managed water purifier according to an exemplary embodiment of the present invention.

FIG. 4 is a view illustrating a state in which a front cover unit is rotated to expose a tank coupling module unit forward in a self-managed water purifier according to an exemplary embodiment of the present invention.

FIG. 5 is a view illustrating a state in which the tank coupling module unit is pulled forward and separated in a self-managed water purifier according to an exemplary embodiment of the present invention.

FIG. 6 is a view illustrating an example of a sensor module constituting the tank coupling module unit applied to a self-managed water purifier according to an exemplary embodiment of the present invention.

FIG. 7 is a view illustrating an example of a discharge module constituting the tank coupling module unit applied to a self-managed water purifier according to an exemplary embodiment of the present invention.

FIG. 8 is an enlarged view of portion A showing the sensor module side of the self-managed water purifier in FIG. 3 according to an exemplary embodiment of the present invention.

FIG. 9 is a view exemplarily illustrating a state in which the sensor module is separated in FIG. 8.

FIG. 10 is an enlarged view of portion B showing the discharge module side of the self-managed water purifier in FIG. 3 according to an exemplary embodiment of the present invention.

FIG. 11 is a view exemplarily illustrating a state in which the discharge module is separated in FIG. 10.

FIG. 12 is a view illustrating an example of a self-managed water purifier according to another embodiment of the present invention.

FIG. 13 is a view exemplarily illustrating a coupled state of a discharge module provided in the self-managed water purifier of FIG. 12 according to another embodiment of the present invention.

### BEST MODES FOR CARRYING OUT THE INVENTION

In the best mode, the present invention provides a self-managed water purifier comprising: a housing; a tank accommodated in an internal space of the housing, storing purified water, and including a tank discharge port; a tank coupling module unit detachably coupled to an outer side of the tank and in fluid communication with the tank through the tank discharge port; a valve unit coupled to the tank discharge port while connecting the tank coupling module unit to the tank, the valve unit opening the tank discharge port when the tank coupling module unit is coupled to the tank and closing the tank discharge port when the tank coupling module unit is separated from the tank; a frame unit accommodated in the internal space of the housing and supporting the tank coupling module unit; and a front cover unit detachably coupled to a front panel forming a front portion of the housing in a size and shape that can cover the tank coupling module unit, and selectively exposing the tank coupling module unit to the outside.

In addition, in the best mode, the present invention provides a self-managed water purifier comprising: a housing; a purified water discharge port accommodated in an internal space of the housing and discharging purified water filtered through a filter unit; a frame unit accommodated in the internal space of the housing; a discharge module unit detachably coupled to the frame unit, in fluid communication with the purified water discharge port, and discharging the purified water from the purified water discharge port to the outside; a valve unit coupled to the purified water discharge port, the valve unit opening the purified water discharge port when the discharge module unit is coupled to the purified water discharge port and closing the purified water discharge port when the discharge module unit is separated from the discharge port; and a front cover unit detachably coupled to a front panel forming a front portion of the housing in a size and shape that can cover the discharge module unit, and selectively exposing the discharge module unit to the outside.

### Modes of the Invention

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

The words and terms used in the present specification and claims should not be interpreted as being limited to their ordinary or dictionary meanings, but should be construed as having meanings and concepts consistent with the technical spirit of the present invention, in accordance with the principle that an inventor may define terms and concepts to best describe their invention.

Accordingly, the embodiments described in the present specification and the configurations shown in the drawings correspond to preferred embodiments of the present invention, and do not represent all the technical spirit of the present invention, so the configurations may have various examples of equivalent and modification that can replace them at the time of filing the present invention.

It should be understood that the terms “comprise or include” or “have” or the like when used in this specification, are intended to describe the presence of stated features, numbers, steps, operations, elements, components and/or a combination thereof but not preclude the possibility of the presence or addition of one or more other features, numbers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

Additionally, in describing the present invention, detailed descriptions of related known functions or configurations will be omitted in order to not obscure the gist of the present invention.

Hereinafter, a self-managed water purifier 1 according to an exemplary embodiment of the present invention will be described with reference to the drawings.

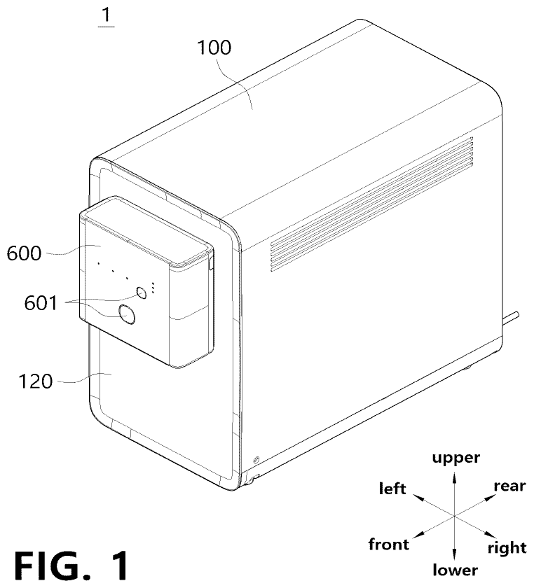

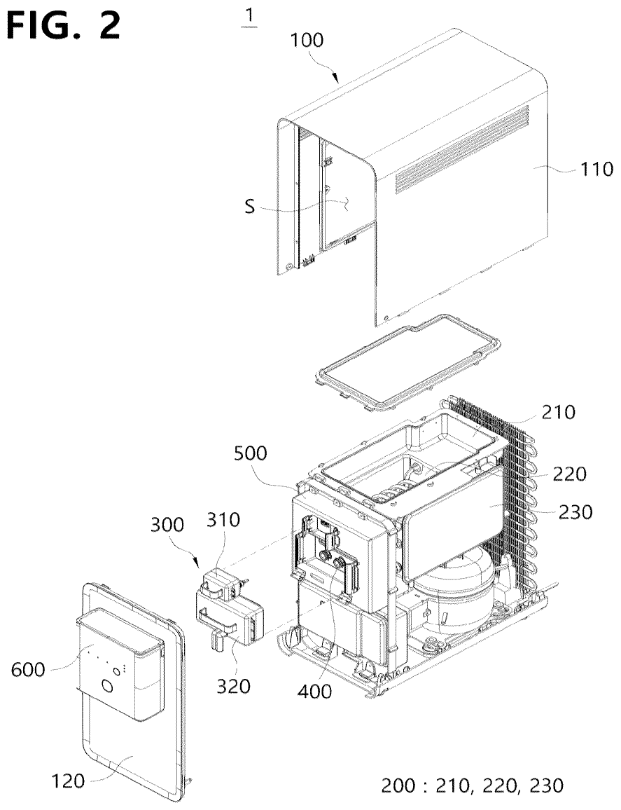

FIGS. 1 to 11 are views illustrating the self-managed water purifier according to an exemplary embodiment of the present invention and various modules and components included therein.

Referring to FIGS. 1 to 11, a self-managed water purifier 1 according to an exemplary embodiment of the present invention is configured to allow easy replacement of a tank coupling module unit 300 that is in fluid communication with a tank 200 through a tank discharge port 201 in a water storage type water purifier including the tank 200, without requiring any prior action to block leakage of raw or purified water.

To this end, the self-managed water purifier 1 according to the exemplary embodiment of the present invention broadly includes a housing 100, a tank 200, a tank coupling module unit 300, a valve unit 400, a frame unit 500, and a front cover unit 600.

The tank coupling module unit 300 is configured as an assembly-type structure that can be mounted inside the housing 100 to be in fluid communication with the tank 200 when necessary.

First, the housing 100 defines the overall size of the self-managed water purifier 1 and has an enclosure shape including an outer panel 110 and a front panel 120, with an internal space S in which various components can be arranged.

In addition, the tank 200 is accommodated in the internal space S of the housing 100 and serves to store purified water. In addition, the tank 200 includes, on one side, a tank discharge port 201 through which the purified water can be discharged to the outside.

The tank 200 includes at least two of a purified water tank 210, a cold water tank 220, and a hot water tank 230. However, the configuration is not limited thereto, and any one of the tanks may be provided as needed.

Meanwhile, the tank coupling module unit 300 is detachably coupled to the outer side of the tank 200 and is in fluid communication with the tank 200 through the tank discharge port 201.

For example, the tank coupling module unit 300 has a structure including a main body 301 having an internal accommodating space, and a flow path pipe 302 extending rearward from the main body 301 while being in fluid communication with the internal accommodating space.

The tank coupling module unit 300 may be a sensor module 310 configured to check the temperature or the amount of purified water inside the tank 200, or a discharge module 320 configured to discharge the purified water stored in the tank 200 to the outside under the control of a controller.

Meanwhile, the tank coupling module unit 300 may be configured such that the sensor module 310 and the discharge module 320 are provided as separate, independent modules, or may also be configured as an integrated module in which the sensor module 310 and the discharge module 320 arc contained within a single main body.

The tank coupling module unit 300 has a structure that allows it to be detachably coupled to and separated from the front of the self-managed water purifier 1 according to the needs of a user.

In this case, to prevent the purified water stored in the tank 200 from being unintentionally discharged to the outside when the tank coupling module unit 300 is detachably coupled or separated, a valve unit 400 is included.

The valve unit 400 is configured to be coupled to the tank discharge port 201 while connecting the tank coupling module unit 300 to the tank 200.

In addition, the valve unit 400 opens the tank discharge port 201 when the tank coupling module unit 300 is coupled to the tank 200, and closes the tank discharge port 201 when the tank coupling module unit 300 is separated from the tank 200, thereby preventing external leakage of the purified water stored in the tank 200.

Meanwhile, the valve unit 400 may be implemented as a check valve employing a mechanical shut-off mechanism using an clastic member, depending on the blocking structure of the tank discharge port 201. Alternatively, it may be a solenoid valve employing an electrical shut-off mechanism that opens or closes the valve by detecting the coupling or separation of the tank coupling module unit 300 through electrical means, or a magnetic shut-off valve configured to detect the coupling or separation of the tank coupling module unit 300 using a magnet or the like.

In the self-managed water purifier 1 according to an embodiment of the present invention, an embodiment employing a check valve structure is illustrated to facilitate easy attachment and detachment of the tank coupling module unit 300 and allow simple replacement while enhancing the water shut-off effect. However, the present invention is not limited thereto.

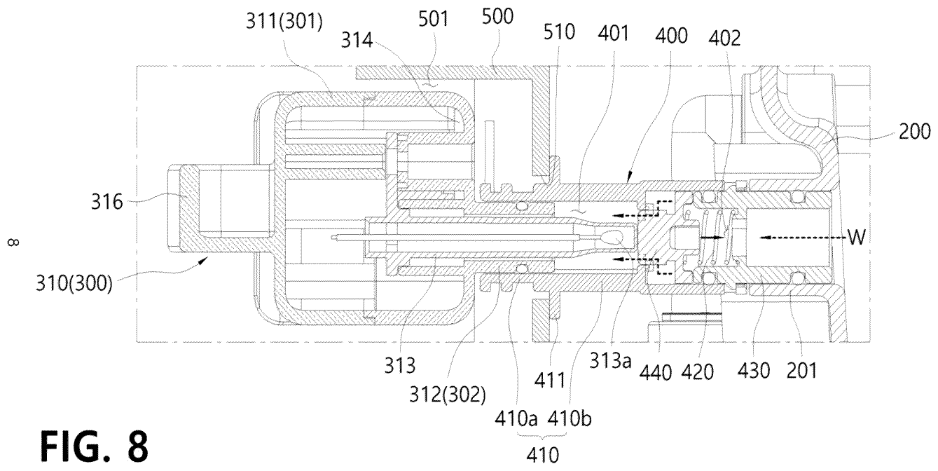

Referring to FIGS. 8 to 11, the valve unit 400 applied to the self-managed water purifier 1 according to an exemplary embodiment of the present invention will now be described in more detail as follows.

In an embodiment of the present invention, the valve unit 400 has the form of a check valve that performs valve opening and closing using a mechanical shut-off mechanism employing an elastic member.

Specifically, the valve unit 400 includes a body 410, an elastic spring 420, a flow path coupling member 430, and an opening/closing member 440, and the flow of purified water is controlled by compression or release of the opening/closing member 440.

The body 410 has a tubular shape and is formed with a first flow path hole 401 through which the flow path pipe 302 of the tank coupling module unit 300 is inserted.

In addition, the elastic spring 420 is accommodated in a rear region of the body 410.

In addition, the flow path coupling member 430 has one side that supports the rear end of the elastic spring 420 and is coupled to the body 410, and the other side that is inserted into and coupled to the tank discharge port 201. In addition, the flow path coupling member 430 is formed with a second flow path hole 402 that is in fluid communication with the first flow path hole 401. Preferably, the flow path coupling member 430 has a tubular shape.

The opening/closing member 440 is provided at a front end of the elastic spring 420 and opens or closes the first flow path hole 401 by the elastic force of the elastic spring 420.

In other words, in the valve unit 400 applied to the present invention, the flow of purified water is controlled by compression or release of the opening/closing member 440.

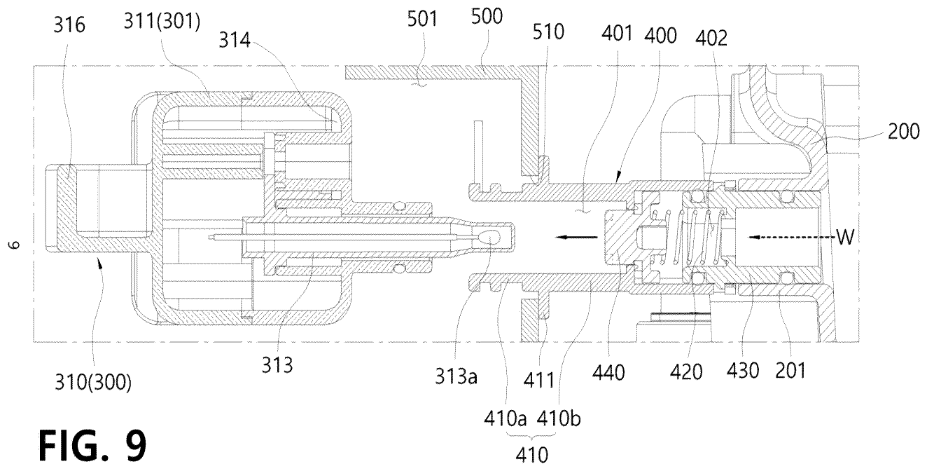

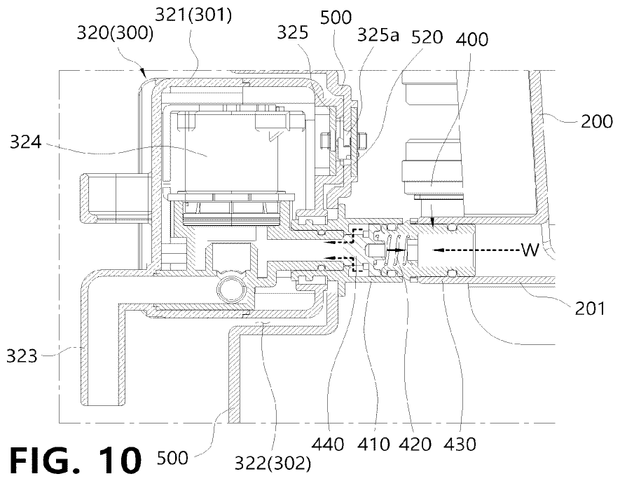

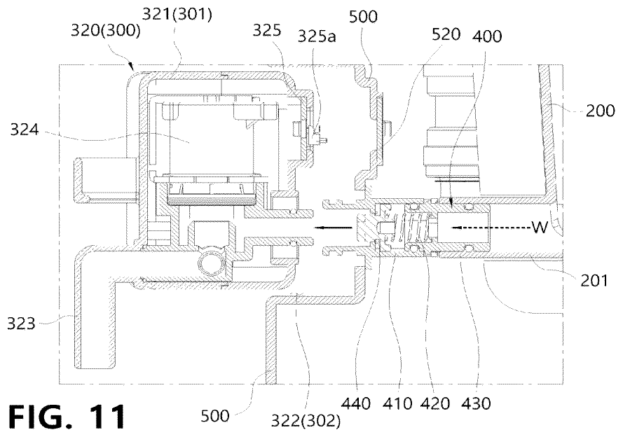

For example, the opening/closing member 440 may be configured such that, depending on its shape, the front portion has a “+” shape, and when it is pushed rearward by physical force as shown in FIGS. 8 and 10 (release of compression), the first flow path hole 401 is opened to form a lateral flow path, allowing purified water (W) to flow from the tank discharge port 201 through the second flow path hole 402 to the first flow path hole 401, and when the physical force is removed and the member is compressed forward as shown in FIGS. 9 and 11, the first flow path hole 401 is closed to shut off the flow path, thereby preventing the purified water (W) from being discharged to the outside.

Meanwhile, the body 410 further includes a coupling protrusion 411 formed to protrude laterally from an outer circumferential surface.

The coupling protrusion 411 of the body 410 is fitted into a mounting hole 510 formed in the frame unit 500, which will be described later, and is thereby supported. That is, the valve unit 400 can be prevented from being detached forward from the frame unit 500 by the coupling protrusion 411.

Meanwhile, the body 410 may be divided into a first pipe 410a that extends toward the tank coupling module unit 300 in front of the coupling protrusion 411, and a second pipe 410b that extends toward the tank 200 behind the coupling protrusion 411.

The flow path pipe 302 of the tank coupling module unit 300 is inserted into the first flow path hole 401 of the first pipe 410a.

Meanwhile, the frame unit 500, which constitutes the self-managed water purifier 1 according to an exemplary embodiment of the present invention, is accommodated in the internal space S of the housing 100 and serves to support the tank coupling module unit 300. To this end, the frame unit 500 includes module seating grooves 501 and 502 that correspond in shape to the tank coupling module unit 300, so that the tank coupling module unit 300 can be seated therein.

In addition, the frame unit 500 is supported by the tank 200 or other components within the housing 100.

Meanwhile, the front cover unit 600 prevents the tank coupling module unit 300 from being exposed to the outside of the housing 100, while also allowing the tank coupling module unit 300 to be exposed when replacement of the tank coupling module unit 300 is needed, thereby facilitating easy replacement.

To this end, the front cover unit 600 is detachably coupled to the front panel 120 forming a front portion of the housing 100 in a size and shape sufficient to cover the tank coupling module unit 300. In addition, the front cover unit 600 selectively exposes the tank coupling module unit 300 to the outside.

The front cover unit 600 may have an enclosure shape protruding forward from the front panel 120, or may be formed as an openable structure that constitutes a part of the front panel 120.

Meanwhile, the front panel 120 includes an opening hole 121 having a size sufficient to allow the tank coupling module unit 300 to be exposed to the outside. Through the opening hole 121, the module seating grooves 501 and 502 of the frame unit 500 are exposed to the outside, allowing the user to couple or separate the tank coupling module unit 300 to/from the tank 200.

In an embodiment of the present invention, the front cover unit 600 is illustrated as having an enclosure shape with an open rear side and being coupled to the front of the front panel 120 while covering the opening hole 121 of the front panel 120.

The front cover unit 600 has a structure that includes an operation button 601, which allows a user to select the operation of the self-managed water purifier 1, and a discharge hole 602 through which a faucet 323 for discharging purified water is downwardly protruded.

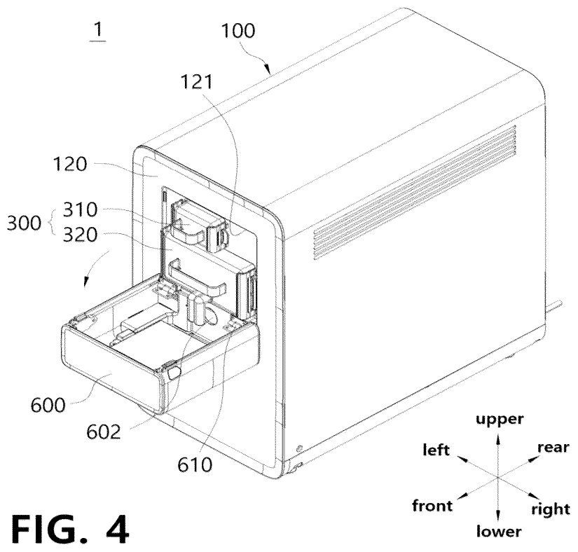

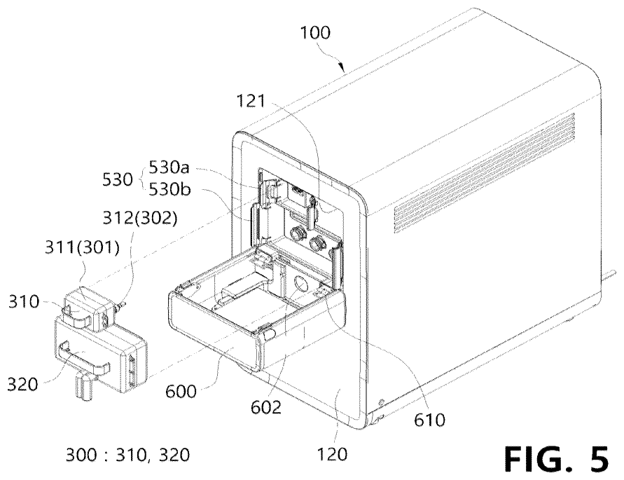

Referring again to FIGS. 4 and 5, a lower end of the front cover unit 600, which is in contact with the front panel 120, is rotatably coupled to the front panel 120 through a rotation member 610.

In this case, preferably, the faucet 323 has a structure that does not interfere with the front cover unit 600 when the front cover unit 600 rotates.

For example, the discharge hole 602 of the front cover unit 600 may be formed with a radius larger than that of the faucet 323, the faucet 323 may be configured to have a smaller front-to-rear width than its left-to-right width, and the downward protrusion of the faucet 323 may be configured such that it does not interfere with the rotation path of the discharge hole 602.

In addition, the front cover unit 600 pivots around its lower end, allowing its upper portion to tilt forward and thereby expose the tank coupling module unit 300 to the outside.

If necessary, the upper end of the front cover unit 600, which is in contact with the front panel 120, may be configured to be detachable by the user through a hook-type coupling mechanism or a magnetic coupling mechanism.

As described above, the self-managed water purifier 1 according to an embodiment of the present invention has a structure that eliminates the need for prior actions such as shutting off the raw water supply or completely draining the purified water from the tank 200.

In other words, since the tank coupling module unit 300 is detachably coupled by the valve unit 400, and the tank discharge port 201 is automatically closed by the valve unit 400 when the tank coupling module unit 300 is removed, the replacement of the tank coupling module unit 300, which is in fluid communication with the tank 200, can be easily performed.

In addition, the front cover unit 600 has a structure that is hinged to rotate forward and tilt downward, and the tank coupling module unit 300 has a structure that is exposed forward to allow the user to easily perform replacement.

Accordingly, when the tank coupling module unit 300 is separated forward, it is not obstructed by other structural components, allowing for easy replacement.

Meanwhile, when the front cover unit 600 is hinge-rotated and tilted downward, it may temporarily support the tank coupling module unit 300 during replacement of the tank coupling module unit 300, thereby serving as a kind of workbench.

Preferably, the tilted front cover unit 600 may be provided with a separate protective plate (not shown) or a waterproof material to prevent purified water from penetrating.

Meanwhile, although the front cover unit 600 has been illustrated as having a structure that is hinged to rotate and tilt open, the front cover unit 600 may also be configured to be completely detached or removed, if necessary, to facilitate the replacement of the tank coupling module unit 300.

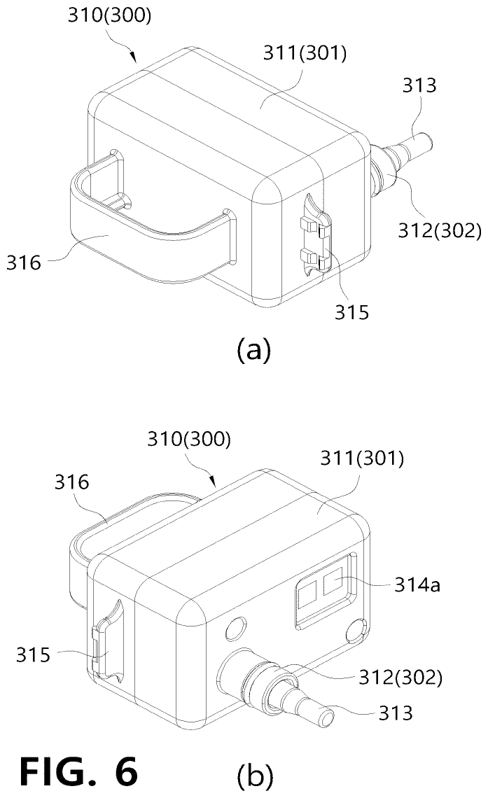

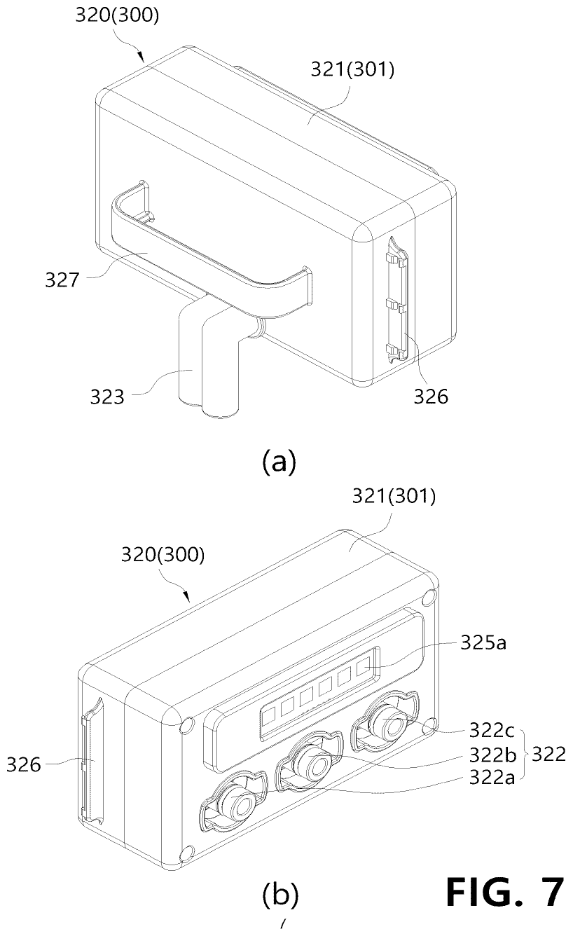

Meanwhile, referring again to FIGS. 6 and 7, the tank coupling module unit 300, which constitutes the self-managed water purifier 1 according to an embodiment of the present invention, may have a modular structure in which various components that require fluid communication with the tank 200 are modularized.

For example, the tank coupling module unit 300 may be a sensor module 310 including a sensor for measuring the temperature of the purified water in the tank 200 or the amount of purified water.

For example, the tank coupling module unit 300 may be a discharge module 320 including a faucet 323 for discharging the purified water in the tank 200 to the outside so that the user can drink it under control.

First, referring to FIG. 6 along with FIGS. 8 and 9, the sensor module 310, which constitutes the tank coupling module unit 300, will be described in more detail as follows.

The sensor module 310 is detachably coupled to the front of the tank 200 while being supported by the frame unit 500. In addition, the sensor module 310 comes into contact with the purified water introduced through the valve unit 400 and detects the temperature or water level of the purified water inside the tank 200.

Referring again to FIG. 6, for example, the sensor module 310 includes a sensor module main body 311, a sensor module flow path pipe 312, a sensing tube 313, and a circuit board 314.

The sensor module main body 311 has an enclosure shape with an internal accommodating space.

The sensor module flow path pipe 312 extends rearward from the sensor module main body 311 while being in fluid communication with the internal accommodating space of the sensor module main body 311 and is connected to the valve unit 400.

The sensing tube 313 has a structure in which one side thereof is supported in the internal accommodating space of the sensor module main body 311 and the other side is disposed to penetrate the sensor module flow path pipe 312 while being sealed. The sensing tube 313 may be provided, in its interior, with a sensor 313a (see FIG. 8) configured to measure the temperature or check the amount of purified water.

The sensor 313a may, as needed, have an airtight configuration and protrude outward from the sensing tube 313, or may be disposed inside the sensing tube 313, as illustrated in FIG. 8.

For example, when the sensor 313a functions as a temperature sensor, it may be provided on the outside of the sensing tube 313 to check the temperature of the purified water through direct contact with the water, or it may be provided inside the sensing tube 313 to check the temperature of the purified water based on the temperature variation transferred into the sensing tube 313.

The configuration of the sensing tube 313 and the sensor 313a is not limited to a specific example, and may vary in shape depending on various sensing methods that involve either contact or non-contact with the purified water.

Meanwhile, the circuit board 314 is electrically connected to the sensor 313a and is provided in the internal accommodating space of the sensor module main body 311 such that a contact terminal 314a protrudes outward from the sensor module main body 311.

In this case, it is preferable that the circuit board 314, which is electrically connected, be sealed to prevent contact with purified water.

Meanwhile, the sensor module 310, which forms part of the tank coupling module unit 300 applied in an embodiment of the present invention, is configured not to directly sense the purified water inside the tank 200, but rather to sense the purified water flowing in through the valve unit 400.

In other words, when the sensor module 310 is coupled to the module seating groove 501, the sensing tube 313 of the sensor module 310 is not positioned to be inserted into the interior of the tank 200, but is instead located inside the valve unit 400.

Referring back to FIG. 8, the sensing tube 313 physically pushes the opening/closing member 440 of the valve unit 400 to allow purified water to flow and is disposed within the space of the first flow path hole 401 of the valve unit 400 so as to sense the water introduced into the space defined by the first flow path hole 401.

As described above, the sensor module 310 of the tank coupling module unit 300 is not configured such that the sensing tube 313 is inserted into the inside of the tank 200 through the tank discharge port 201, but instead is disposed in the valve unit 400 and senses the purified water induced and introduced into the valve unit 400.

Accordingly, since the length of the sensing tube 313 only needs to extend to the valve unit 400, the length of the sensing tube 313 can be adjusted, making the sensor module 310 easier to detach and replace.

In addition, the sensor module flow path pipe 312 and the sensing tube 313 constituting the sensor module 310 may each be formed in a number of at least one, as necessary.

The sensor module flow path pipe 312 including a plurality of sensing tubes 313 in a single tank 200 may be configured to be in fluid communication with the tank discharge port 201.

Alternatively, each of a plurality of tanks 200—namely, the purified water tank 210, cold water tank 220, and hot water tank 230—may be fluidly connected, via a respective tank discharge port 201, to a corresponding sensor module flow path pipe 312 that includes a sensing tube 313.

Meanwhile, a handle 316, shaped to be grasped by a user, is formed at the front of the sensor module main body 311, which constitutes the sensor module 310.

In addition, mounting members 315 protruding laterally are formed on both sides of the sensor module main body 311, and the mounting members 315 are detachably coupled to locking members 530a rotatably disposed on the frame unit 500.

The detachable coupling structure between the mounting member 315 and the locking member 530a may employ various known coupling methods, such as a hook-type coupling mechanism, and the specific structure and function thereof will be omitted herein so as not to obscure the gist of the present invention.

Meanwhile, referring to FIG. 7 along with FIGS. 10 and 11, the discharge module 320, which constitutes the tank coupling module unit 300, will now be described in more detail as follows.

The discharge module 320 is detachably coupled to the front of the tank 200 while being supported by the frame unit 500. In the illustrated example, the discharge module 320 is disposed below the sensor module 310, but it is not limited thereto and may be positioned at any convenient location on the front side of the self-managed water purifier 1.

The discharge module 320 includes a faucet 323 and discharges the purified water in the tank 200 to the outside through the valve unit 400.

In this case, the purified water in the tank 200 may be room-temperature purified water from the purified water tank 210, cold water from the cold water tank 220, or hot water from the hot water tank 230.

Referring again to FIG. 7, the discharge module 320 includes a discharge module main body 321, a discharge module flow path pipe 322, a faucet 323, a solenoid valve 324, and a circuit board 325.

The discharge module main body 321 has an enclosure shape forming an internal accommodating space.

The discharge module flow path pipe 322 extends rearward from the discharge module main body 321 while being in fluid communication with the internal accommodating space of the discharge module main body 321. In addition, the discharge module flow path pipe 322 is connected to the first flow path hole 401 of the body 410 of the valve unit 400.

The faucet 323 is connected to the discharge module flow path pipe 322 within the internal accommodating space and has a tubular shape extending outward from the discharge module main body 321.

The solenoid valve 324 is disposed within the internal accommodating space of the discharge module main body 321 and serves to connect the discharge module flow path pipe 322 to the faucet 323. In addition, in response to an electrical control signal, the solenoid valve 324 discharges the purified water—introduced into the discharge module flow path pipe 322 through the tank discharge port 201 and the valve unit 400—to the outside via the faucet 323.

Meanwhile, the circuit board 325 is electrically connected to the solenoid valve 324 and is provided within the internal accommodating space such that a contact terminal 325a protrudes outward from the discharge module main body 321.

In this case, it is preferable that the circuit board 325, which is electrically connected, be sealed to prevent contact with purified water.

In addition, the discharge module flow path pipe 322 and the faucet 323 constituting the discharge module 320 may each be formed in a number of at least one, as necessary.

When the tank 200 includes at least two or more tanks, such as the purified water tank 210, cold water tank 220, or hot water tank 230, each discharge module flow path pipe 322 and faucet 323 has a structure that is in fluid communication with its corresponding tank.

Meanwhile, a handle 327, shaped to be grasped by a user, is formed at the front of the discharge module main body 321, which constitutes the discharge module 320.

In addition, mounting members 326 protruding laterally are formed on both sides of the discharge module main body 321, and the mounting members 326 are detachably coupled to locking members 530b rotatably disposed on the frame unit 500.

The detachable coupling structure between the mounting member 326 and the locking member 530b may employ various known coupling methods, such as a hook-type coupling mechanism, and the specific structure and function thereof will be omitted herein so as not to obscure the gist of the present invention.

As described above, the tank coupling module unit 300 applied to the self-managed water purifier 1 according to an embodiment of the present invention includes a sensor module 310 and a discharge module 320, and the sensor module 310 and the discharge module 320 are fluidly connected to the purified water in the tank 200 through pressing or releasing of the opening/closing member 440 of the valve unit 400.

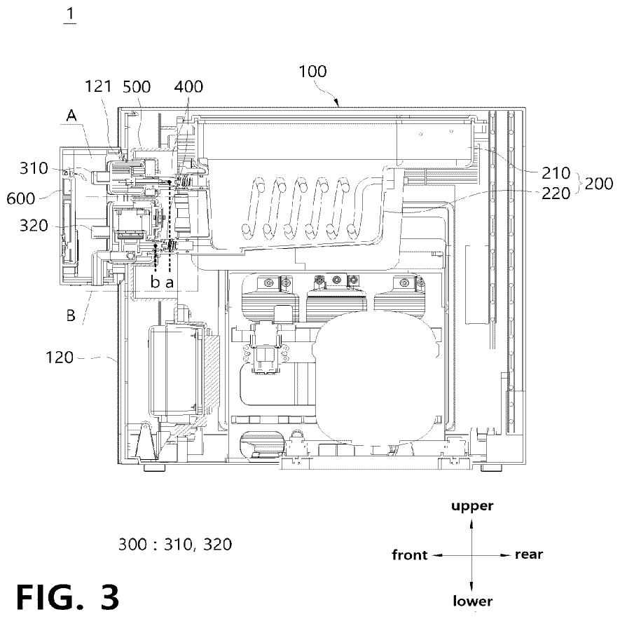

Meanwhile, referring again to FIGS. 3, 8, and 10, the point (a in FIG. 3) at which the sensor module 310 physically pushes the opening/closing member 440 of the valve unit 400 is located closer to the tank 200 than the point (b in FIG. 3) at which the discharge module 320 physically pushes the opening/closing member 440.

The discharge module 320 is configured for the purpose of fluidly communicating purified water in the tank 200 and discharging it to the outside. Since an increased length of the flow path pipe 322 would result in a larger amount of residual water upon removal, the length of the flow path pipe 322 is kept as short as possible so that the valve unit 400 is opened or closed at a position relatively close to the front side of the housing 100.

In addition, the sensor module 310 is configured for the purpose of retaining the purified water in the tank 200 in the valve unit 400 while maintaining its properties (temperature, water level, etc.) so as to facilitate sensing. Therefore, the length of the flow path pipe 322 or the sensing tube 313 is increased so that the valve unit 400 is opened or closed at a position relatively close to the tank 200.

Meanwhile, the frame unit 500 is provided with a terminal portion 520 that is electrically connected to the sensor module 310 through contact with the terminal 314a, and has a sensor module seating groove 501 in which the sensor module 310 is seated and accommodated from the front toward the rear.

In addition, the frame unit 500 is provided with a terminal portion 520 that is electrically connected to the discharge module 320 through contact with the terminal 325a, and has a discharge module seating groove 502 in which the discharge module 320 is seated and accommodated from the front toward the rear.

In this case, the terminal portion 520 of the frame unit 500 may be the same terminal portion as the terminal portion 520 that is electrically connected to the discharge module 320 to be described later, and, if necessary, may be configured in a form divided into a first terminal portion that contacts the sensor module 310 and a second terminal portion that contacts the discharge module 320.

Meanwhile, as described above, the tank 200 applied to the self-managed water purifier 1 according to an embodiment of the present invention includes at least two or more of a purified water tank 210, a cold water tank 220, and a hot water tank 230.

In this case, the tank coupling module unit 300 is detachably coupled to at least two or more of the purified water tank 210, the cold water tank 220, and the hot water tank 230.

As described above, the self-managed water purifier 1 according to an embodiment of the present invention has been described with reference to FIGS. 1 to 11. The self-managed water purifier 1 illustrated in FIGS. 1 to 11 is a water storage-type water purifier that stores purified water in the tank 200 including the tank discharge port 201, and is configured to discharge the purified water to the outside through the faucet 323 of the discharge module 320 according to a control signal.

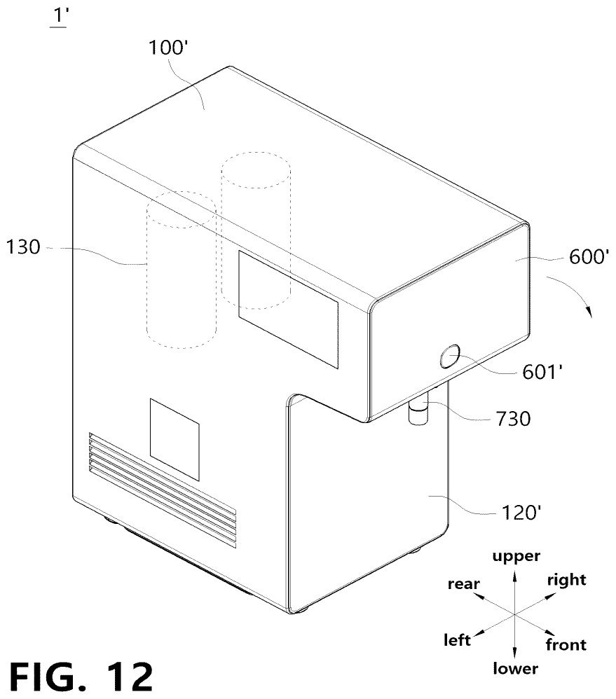

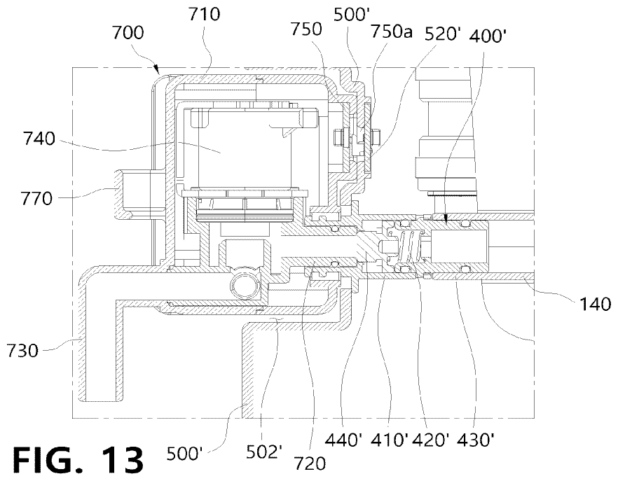

Meanwhile, FIG. 12 is a view illustrating an example of a self-managed water purifier according to another embodiment of the present invention, and FIG. 13 is a view exemplarily illustrating a coupled state of a discharge module provided in the self-managed water purifier of FIG. 12 according to another embodiment of the present invention.

The self-managed water purifier 1′ according to another embodiment of the present invention includes a purified water discharge port 140 that discharges purified water filtered through a filter unit 130, and a discharge module unit 700 in fluid communication with the purified water discharge port 140.

Even in a direct water purifier including the purified water discharge port 140 for discharging the filtered purified water, the discharge module unit 700 having a coupling part with the purified water discharge port 140 can be simply and easily replaced without a preliminary operation to prevent leakage of raw water.

In FIG. 12, the self-managed water purifier 1′ according to another embodiment of the present invention is a direct water purifier in which a filter unit 130, including at least two filters for purifying raw water by removing foreign substances contained therein, is provided inside the housing 100′.

Purified water filtered through the filter unit 130 is brought into fluid communication with the purified water discharge port 140 via an internal flow path, and is selectively discharged to the outside through the discharge module unit 700, which includes a faucet 730, according to a control signal.

The structure and functions of such a direct water purifier include known functions and structures, and a detailed description thereof will be omitted so as not to obscure the gist of the present invention.

However, referring to FIGS. 12 and 13, the self-managed water purifier 1′ according to an embodiment of the present invention is configured to allow easy replacement of the discharge module unit 700 from the front.

To this end, the self-managed water purifier 1′ generally includes a housing 100′, a purified water discharge port 140, a valve unit 400′, a frame unit 500′, and a front cover unit 600′.

First, the housing 100′ determines the size of the self-managed water purifier 1′ and has an enclosure shape with an internal space in which the respective components can be arranged.

In addition, the frame unit 500′ is accommodated inside the housing 100′ and supports the discharge module unit 700 and the valve unit 400′. In this case, the frame unit 500′ is provided with a discharge module unit seating groove 502′ in which the discharge module unit 700 is seated, and is formed in a bent plate shape arranged inside the housing 100′. The shape of the frame unit 500′ is not limited to a specific configuration, and various shapes may be applied as long as the discharge module unit 700 can be stably supported.

In addition, the discharge module unit 700 is detachably coupled to the frame unit 500′ and is in fluid communication with the purified water discharge port 140. In addition, the discharge module unit 700′ discharges the purified water from the purified water discharge port 140 to the outside.

The discharge module unit 700′ has a structure that allows it to be detachably coupled to and separated from the front of the self-managed water purifier 1′ according to the needs of a user.

In this case, the discharge module unit 700′ includes the valve unit 400′ to prevent purified water from being unintentionally leaked to the outside when the discharge module unit 700′ is detachably coupled to or separated from the purified water discharge port 140.

The valve unit 400′ is configured to be coupled to the purified water discharge port 140 while connecting the discharge module unit 700 to the purified water discharge port 140.

And the valve unit 400′ opens the purified water discharge port 140 when the discharge module unit 700 is coupled to the purified water discharge port 140, and closes the purified water discharge port 140 when the discharge module unit 700 is separated from the purified water discharge port 140.

Meanwhile, the valve unit 400′ may be implemented as a check valve employing a mechanical shut-off mechanism using an elastic member, depending on the type of blocking structure. Alternatively, it may be a solenoid valve employing an electrical shut-off mechanism that opens or closes the valve by detecting the coupling or separation of the discharge module unit 700 through electrical means, or a magnetic shut-off valve configured to detect the coupling or separation of the tank coupling module unit 300 using a magnet or the like.

In the self-managed water purifier 1′ according to an embodiment of the present invention, an embodiment employing a check valve structure is illustrated to facilitate easy attachment and detachment of the discharge module unit 700 and allow simple replacement while enhancing the water shut-off effect. However, the present invention is not limited thereto.

Specifically, the valve unit 400′ includes a body 410′, an elastic spring 420′, a flow path coupling member 430′, and an opening/closing member 440′, and the flow of purified water is controlled by compression or release of the opening/closing member 440′.

The body 410′ has a tubular shape in which a first flow path hole, into which the discharge module unit flow path pipe 720 of the discharge module unit 700 is inserted, is formed to penetrate.

The structure and function of the valve unit 400′ are identical to those of the valve unit 400 described in detail with reference to FIGS. 8 to 11, and thus a detailed description thereof will be omitted so as not to depart from the gist of the present invention.

Meanwhile, the front cover unit 600′ blocks the discharge module unit 700 from being exposed to the outside of the housing 100′, while allowing the discharge module unit 700 to be exposed to the outside when replacement of the discharge module unit 700 is required, thereby facilitating easy replacement.

To this end, the front cover unit 600′ is detachably coupled to the front panel 120′ forming a front portion of the housing 100′ in a size and shape sufficient to cover the discharge module unit 700. In addition, the front cover unit 600′ selectively exposes the discharge module unit 700 to the outside.

The front cover unit 600′ may have an enclosure shape protruding forward from the front panel 120′, or may be formed as an openable structure that constitutes a part of the front panel 120′.

Meanwhile, the front panel 120′ includes an opening hole having a size sufficient to allow the discharge module unit 700 to be exposed to the outside. Through the opening hole, the discharge module unit seating groove 502′ of the frame unit 500′ is exposed to the outside, allowing the user to couple or separate the discharge module unit 700 to/from the purified water discharge port 140.

In an embodiment of the present invention, the front cover unit 600′ is illustrated as having a plate shape with the front panel 120′ extended upward to cover the opening hole while forming a part of the front panel 120′.

The front cover unit 600′ includes an operation button 601′ that allows a user to select the operation of the self-managed water purifier 1′, and has a structure in which the faucet 730, through which purified water is discharged to the outside, is arranged to protrude downward.

The front cover unit 600′ has its lower end pivotally coupled via a rotation member. In addition, the front cover unit 600′ pivots around its lower end, allowing its upper portion to tilt forward and thereby expose the discharge module unit 700 to the outside.

As described above, the self-managed water purifier 1′ according to an embodiment of the present invention has a structure that prevents a preliminary operation for shutting off the inflow of raw water.

In other words, the discharge module unit 700 is detachably coupled to the purified water discharge port 140 by the valve unit 400′, and the purified water discharge port 140 is automatically closed when the discharge module unit 700 is separated by the valve unit 400′, thereby providing a structure that facilitates replacement of the discharge module unit 700.

The front cover unit 600′ has a structure that is hinged to rotate forward and tilt downward, and the discharge module unit 700 has a structure that is exposed forward to allow the user to easily perform replacement.

Accordingly, when the discharge module unit 700 is separated forward, it is not obstructed by other structural components, allowing for easy replacement.

Meanwhile, referring to FIG. 13, in one embodiment, the discharge module unit 700 has a structure that includes a discharge module unit main body 710, a discharge module unit flow path pipe 720, a faucet 730, a solenoid valve 740, and a circuit board 750.

The discharge module unit main body 710 has an enclosure shape with an internal accommodating space.

In addition, the discharge module unit flow path pipe 720 has a structure that is in fluid communication with the internal accommodating space of the discharge module unit main body 710, extends rearward from the discharge module unit main body 710, and is connected to the valve unit 400′.

In addition, the faucet 730 is connected to the discharge module unit flow path pipe 720 within the internal accommodating space of the discharge module unit main body 710 and has a tubular shape extending to the outside of the discharge module unit main body 710.

Meanwhile, the solenoid valve 740 is disposed in the internal accommodating space of the discharge module unit main body 710 to connect the discharge module unit flow path pipe 720 and the faucet 730, and discharges purified water toward the faucet 730 according to an electrical control signal.

Meanwhile, the circuit board 750 is electrically connected to the solenoid valve 740 and is provided in the internal accommodating space of the discharge module unit main body 710 such that a contact terminal 750a protrudes to the outside of the discharge module unit main body 710.

Meanwhile, in the self-managed water purifier l′ according to another embodiment of the present invention, the purified water discharge port 140 may have a structure including at least two of a purified water discharge port for discharging purified water at room temperature, a purified water discharge port for discharging purified water at a high temperature, and a purified water discharge port for discharging purified water at a low temperature.

In this case, the discharge module unit 700 has a structure that is detachably coupled to at least two of a purified water discharge port for discharging purified water at room temperature, a purified water discharge port for discharging purified water at a high temperature, and a purified water discharge port for discharging purified water at a low temperature.

To this end, the discharge module unit 700 may be provided in a form in which at least two discharge module unit flow path pipes 720 and faucets 730 arc provided.

Meanwhile, a handle 770, shaped to be grasped by a user, is formed at the front of the discharge module unit main body 710, which constitutes the discharge module unit 700.

In addition, mounting members protruding laterally are formed on both sides of the discharge module unit main body 710, and the mounting members are detachably coupled to locking members rotatably disposed on the frame unit 500′. Since the detachable coupling structure using the mounting members and the locking members is the same as that of the tank coupling module unit 300 illustrated in FIGS. 1 to 11, a detailed description thereof will be omitted.

As described above, the self-managed water purifiers 1 and 1′ according to embodiments of the present invention facilitate the replacement of the tank coupling module unit 300 connected through the tank discharge port 201 in a water storage-type water purifier and the discharge module unit 700 connected through the purified water discharge port 140 in a direct water purifier, and allow such replacement to be performed simply and easily without a preliminary action for preventing raw water leakage.

The valve units 400 and 400′ may automatically close the tank discharge port 201 or the purified water discharge port 140 when the tank coupling module unit 300 or the discharge module unit 700 is replaced.

The front cover units 600 and 600′ are hinge-rotated forward and tilted downward to induce exposure of the tank coupling module unit 300 or the discharge module unit 700 to the outside, thereby allowing a user to easily grasp and replace the tank coupling module unit 300 or the discharge module unit 700 from the front.

Although exemplary embodiments of the present invention have been described, the spirit of the present invention is not limited to the embodiments set forth herein. Those of ordinary skill in the art who understand the spirit of the present invention may easily propose other embodiments through supplement, change, removal, addition, etc. of elements within the same scope of spirit, but the embodiments will be also within the scope of the present invention.

1. A self-managed water purifier, comprising:
a housing;
a tank accommodated in an inner space of the housing, configured to store purified water, and including a tank discharge port;
a tank coupling module unit detachably coupled to an outer side of the tank and in fluid communication with the tank through the tank discharge port;
a valve unit coupled to the tank discharge port while connecting the tank coupling module unit and the tank, the valve unit being configured to open the tank discharge port when the tank coupling module unit is coupled to the tank and to close the tank discharge port when the tank coupling module unit is separated from the tank;
a frame unit accommodated in the inner space of the housing and configured to support the tank coupling module unit; and
a front cover unit detachably coupled to a front panel forming a front portion of the housing in a size and shape sufficient to cover the tank coupling module unit, and configured to selectively expose the tank coupling module unit to the outside.

2. The self-managed water purifier of claim 1,
wherein the tank coupling module unit comprises:
a main body having an internal accommodating space; and
a flow path pipe configured to fluidly communicate with the internal accommodating space and extend rearward from the main body.

3. The self-managed water purifier of claim 2,
wherein the valve unit comprises:
a body having a first flow path hole formed therethrough into which the flow path pipe is inserted;
an elastic spring accommodated in a rear region of the body;
a flow path coupling member having one side configured to support a rear side of the elastic spring and coupled to the body, and the other side configured to be inserted into and coupled to the tank discharge port, the flow path coupling member having a second flow path hole formed therein to be in fluid communication with the first flow path hole; and
an opening/closing member provided at a front end of the elastic spring,
wherein a flow of purified water is opened or closed by compression or release of the opening/closing member.

4. The self-managed water purifier of claim 3,
wherein the body is formed with a coupling protrusion protruding laterally from an outer circumferential surface,
and the coupling protrusion is fitted into and supported by a mounting hole formed in the frame unit.

5. The self-managed water purifier of claim 4,
wherein the body is divided into:
a first pipe extending forward from the coupling protrusion and toward the tank coupling module unit, and
a second pipe extending rearward from the coupling protrusion and toward the tank.

6. The self-managed water purifier of claim 1,
wherein the front panel has an opening hole formed therein in a size allowing the tank coupling module unit to be exposed to the outside, and
wherein the front cover unit has an enclosure shape with an open rear and is coupled to a front side of the front panel while covering the opening hole.

7. The self-managed water purifier of claim 6,
wherein a lower end of the front cover unit in contact with the front panel is pivotably coupled to the front panel via a rotation member, and
wherein the front cover unit exposes the tank coupling module unit to the outside by tilting an upper portion forward about the lower end as an axis.

8. The self-managed water purifier of claim 1,
wherein the tank coupling module unit comprises:
a sensor module that is supported by the frame unit and detachably coupled to a front side of the tank, and that detects a temperature or a water level of purified water in the tank by coming into contact with the purified water introduced through the valve unit; and
a discharge module that is supported by the frame unit and detachably coupled to the front side of the tank, and that discharges the purified water introduced through the valve unit to the outside.

9. The self-managed water purifier of claim 8,
wherein the frame unit comprises:
a sensor module seating groove in which the sensor module is accommodated while being seated from front to rear and which is provided with a terminal portion electrically connected to the sensor module through terminal contact; and
a discharge module seating groove in which the discharge module is accommodated while being seated from front to rear and which is provided with a terminal portion electrically connected to the discharge module through terminal contact.

10. The self-managed water purifier of claim 8,
wherein the sensor module comprises:
a sensor module main body having an internal accommodating space;
a sensor module flow path pipe that is in fluid communication with the internal accommodating space, extends rearward from the sensor module main body, and is connected to the valve unit;
a sensing tube having one side supported in the internal accommodating space and the other side arranged to penetrate the sensor module flow path pipe while sealing the sensor module flow path pipe, the sensing tube being provided with a sensor therein; and
a circuit board electrically connected to the sensor and disposed in the internal accommodating space such that a contact terminal protrudes outward from the sensor module main body.

11. The self-managed water purifier of claim 10, wherein the sensor module flow path pipe and the sensing tube are each formed in a number of at least one.

12. The self-managed water purifier of claim 10,
wherein the sensor module main body is formed with mounting members protruding laterally on both sides,
and the mounting members are detachably coupled to locking members rotatably disposed on the frame unit.

13. The self-managed water purifier of claim 8,
wherein the discharge module comprises:
a discharge module main body having an internal accommodating space;
a discharge module flow path pipe that is in fluid communication with the internal accommodating space, extends rearward from the discharge module main body, and is connected to the valve unit;
a faucet connected to the discharge module flow path pipe within the internal accommodating space and extending outward from the discharge module main body;
a solenoid valve disposed in the internal accommodating space and connecting the discharge module flow path pipe to the faucet; and
a circuit board electrically connected to the solenoid valve and disposed in the internal accommodating space such that a contact terminal protrudes outward from the discharge module main body.

14. (canceled)

15. The self-managed water purifier of claim 13,
wherein the discharge module main body is formed with mounting members protruding laterally on both sides,
and the mounting members are detachably coupled to locking members rotatably disposed on the frame unit.

16. The self-managed water purifier of claim 1,
wherein the tank comprises at least two of a purified water tank, a cold water tank, and a hot water tank,
and the tank coupling module unit is detachably coupled to at least two of the purified water tank, the cold water tank, and the hot water tank.

17. A self-managed water purifier, comprising:
a housing;
a purified water discharge port accommodated in an internal space of the housing and configured to discharge purified water filtered through a filter unit;
a frame unit accommodated in the internal space of the housing;
a discharge module unit detachably coupled to the frame unit, fluidly communicating with the purified water discharge port, and configured to discharge the purified water from the purified water discharge port to the outside;
a valve unit coupled to the purified water discharge port, the valve unit opening the purified water discharge port when the discharge module unit is coupled to the purified water discharge port, and closing the purified water discharge port when the discharge module unit is separated from the purified water discharge port; and
a front cover unit detachably coupled to a front panel forming a front portion of the housing in a size and shape sufficient to cover the discharge module unit, and configured to selectively expose the discharge module unit to the outside.

18. The self-managed water purifier of claim 17,
wherein the discharge module unit comprises:
a discharge module unit main body having an internal accommodating space;
a discharge module unit flow path pipe that is in fluid communication with the internal accommodating space, extends rearward from the discharge module unit main body, and is connected to the valve unit;
a faucet connected to the discharge module unit flow path pipe within the internal accommodating space and extending outward from the discharge module unit main body;
a solenoid valve disposed in the internal accommodating space and connecting the discharge module unit flow path pipe to the faucet; and
a circuit board electrically connected to the solenoid valve and disposed in the internal accommodating space such that a contact terminal protrudes outward from the discharge module unit main body.

19. The self-managed water purifier of claim 18,
wherein the valve unit comprises:
a body having a first flow path hole formed therethrough into which the discharge module unit flow path pipe is inserted;
an elastic spring accommodated in a rear region of the body;
a flow path coupling member having one side configured to support a rear side of the elastic spring and coupled to the body, and the other side configured to be inserted into and coupled to the purified water discharge port, the flow path coupling member having a second flow path hole formed therein to be in fluid communication with the first flow path hole; and
an opening/closing member provided at a front end of the elastic spring,
wherein a flow of purified water is opened or closed by compression or release of the opening/closing member.

20. The self-managed water purifier of claim 17,
wherein a lower end of the front cover unit in contact with the front panel is pivotably coupled to the front panel via a rotation member, and
wherein the front cover unit exposes the discharge module unit to the outside by tilting an upper portion forward about the lower end as an axis.

21. The self-managed water purifier of claim 17,
wherein the purified water discharge port comprises at least two of a purified water discharge port for discharging purified water at room temperature, a purified water discharge port for discharging purified water at a high temperature, and a purified water discharge port for discharging purified water at a low temperature,
and the discharge module unit is detachably coupled to at least two of the purified water discharge port for discharging purified water at room temperature, the purified water discharge port for discharging purified water at a high temperature, and the purified water discharge port for discharging purified water at a low temperature.
